(19) United States
(12) Patent Application Publication
(10) Pub. No.: US 2006/0099299 A1
(43) Pub. Date: May 11, 2006

(54) Plasticizing unit for micro injection molding machine

(75) Inventor: Min-Wen Wang, Kaohiun City (TW)

Correspondence Address: BIRCH STEWART KOLASCH & BIRCH, PO BOX 747, FALLS CHURCH, VA, 22040-0747, US

(73) Assignee: National Kaohsiung University of Applied Sciences, Kaohsiung City (TW)

(21) Appl. No.: 11/004,856

(22) Filed: Dec. 7, 2004

(30) Foreign Application Priority Data
Nov. 9, 2004 (TW) 093134124

(51) Int. Cl. B29C 45/46

(52) U.S. Cl. 425/585; 425/587

(57) ABSTRACT

A plasticizing unit for micro injection molding machine, associated with an injection machine, is comprised of a housing and a disk-like rotor, wherein the disk-like rotor is installed inside the housing and kept rotating continuously. When plastic or resin pellets is fed into the housing from an inlet, a heating and mixing process is performed between the disk-like rotor and the inner wall of the housing; and then, the pellets would be transferred into a molten state as non-Newtonian fluid; therefore, while the first vertical normal force in the fluid is greater than the centrifugal force thereof, the molten fluid shall not moves outwardly but would flow inwards to the center of the disk-like rotor by rod climbing effect; therefore, an extrusion pressure would be built up at the disk-like rotor center, by which the molten and well mixed plastic or resin can be delivered from the outlet of the housing to the heating cylinder of the micro injection molding machine, injection molding can be completed through an injection plunger.

### FIELD OF THE INVENTION

The present invention relates to a plasticizing unit for a micro injection molding machine, and, more specifically, to a plasticizing unit which performs melting and mixing plastic or resin fluid utilizing a disk-like rotor.

### BACKGROUND OF THE INVENTION

In addition to the rapid development of plastic industry, the technology for manufacturing of various micro products has become more and more mature. Currently, the products with miniaturized size, high precision and low cost advantages are promoted and applied in many fields; for example, in automobile part, medical equipment, computer, clock as well as watch industries, etc. In fact, micro product produced by injection molding machine has many advantages and great performances that makes them highly evaluated in many fields, and gradually becomes a considerable replacement for some existing metallic micro components.

Referring to FIG. 1, an existing screw type pre-plasticizing injection molding machine (10) comprising a heating screw barrel (11) for performing an expected melting and mixing process, therefore can deliver a melting and mixing plastic or resin to flow into a heating cylinder (12) and kept it in molten status. A driver unit (13) is associated with the heating cylinder (12), which has an injection plunger (14) for injecting the molten plastic or resin from heating cylinder (12) to flow into a mold cavity (not shown) to obtain a molded part. The machine structure as described above may prevent several drawbacks, such as some may arise from injection stroke been too short or a poor plasticizing quality. In order to have a longer stroke and a better resolution, as well as to reach a better speed and good positioning control, the existing machine has minimized the injection plunger (14) in diameter. However, in the barrel (11), the smallest available screw today is about 14 mm in diameter, it still suffers from retaining too much volumes of plastic relative to the part being molded; therefore, the plastic remaining heated in the barrel (11) after each molding cycle shall degrade over time when held at the melting temperature.

Accordingly, using such a small size plasticizing screw may affect the product stability, and if the screw flight depths are smaller than the pellet size, it could lead to the difficulty in transporting the plastic or resin pellet. It would be difficult to obtain micro size and high molding quality demanded by the industry. Deep discussions related the drawbacks of utilizing a miniaturized plasticizing screw, has provided and can refer to U.S. Pat. Nos. 5,380,187 and 6,267,580. However, both of them had not hint us about how to design a plasticizing unit to melt and mix the plastic pellet without the screw barrel; therefore, it is a main point of the present invention.

### SUMMARY OF THE INVENTION

One object of the present invention is to provide an unit for homogeneous plasticizing and associated with an injection molding machine, to fulfill the special requirements of micro injection molding with low resident time and well mixing of the molten plastic or resin.

According to the present invention, an embodiment of the plasticizing unit may comprise a housing and a disk-like rotor, wherein the disk-like rotor is installed inside the housing and kept in running continuously; once the plastic or resin pellet is fed into the housing, a heating and mixing process shall be performed between the disk-like rotor and the inner wall of the housing; and then, the pellet would be transferred into a molten state as non-Newtonian fluid; therefore, while the first vertical normal force in the fluid becomes larger than the centrifugal force thereof, the molten fluid shall not moves outwardly but would flow inwards to the center of the disk-like rotor by rod climbing effect; therefore, an extrusion pressure would be built up at the disk-like rotor center, by which the molten and well mixed plastic or resin can be delivered from the outlet of the housing to a heating cylinder of the micro injection molding machine, injection molding can be completed through an injection plunger.

### DESCRIPTION OF THE DRAWINGS

The foregoing description or other characteristics, objects, features and advantages of the present invention will become more apparent upon consideration of the following detailed description, having reference to the accompanying drawings wherein;

FIG. 1 is a cross-sectional view illustrating an existing screw type pre-plasticizing injection molding machine.

FIG. 2 is a cross-sectional view illustrating the first embodiment of the present invention which is associated with a micro injection molding machine.

FIG. 3 is a cross-sectional view illustrating the second embodiment in accordance with the present invention

FIG. 4 is a cross-sectional view illustrating the third embodiment in accordance with the present invention; and

FIG. 5 is a cross-sectional view illustrating the fourth embodiment in accordance with the present invention

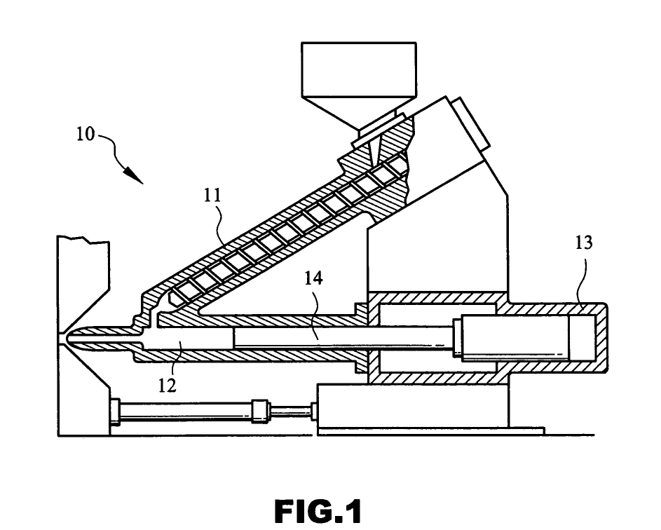

### DETAILED DESCRIPTION OF THE PREFERRED EMBODIMENTS

In order to provide a plasticizing unit to melt and mix the plastic pellet without heating screw barrel, the embodiments in accordance with the present invention are mainly used to replace the heated screw barrel (11) of the existing micro injection molding machine. The basic working principle of this invention is, while a polymeric pellet is fed into and rotating along with a disk-like rotor and molten as a non-Newtonian fluid, a first vertical force therein will resist the centrifugal force and the molten fluid shall not moves outwardly but would flow inwards to the center of the disk-like rotor due to rod climbing effect, and build up an extrusion pressure to deliver the fluid for micro injection.

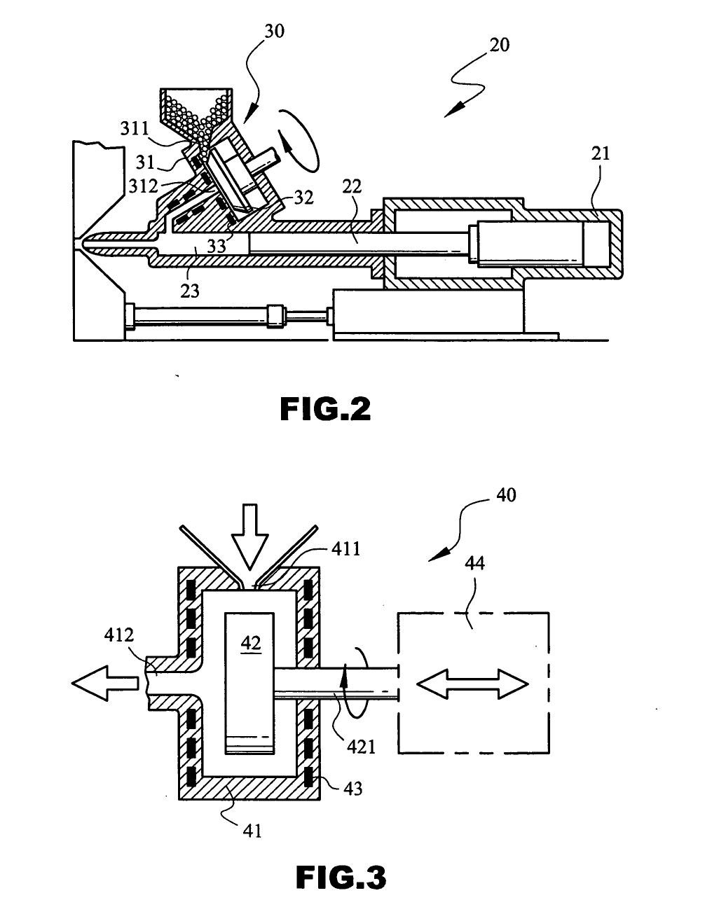

As shown in FIG. 2, a plasticizing unit (30) is embodied according to the present invention, which may comprise a housing (31) and a disk-like rotor (32), wherein the disk-like rotor (32) is kept running in the housing (31) continuously. The polymeric pellet may be a plastic pellet or a resin pellet. The housing (31) heats the plastic or resin pellets inside it by embedded a heater (33). The housing (31) having an inlet (311) and an outlet (312), wherein the position of outlet (312) is preferably next to the center of the disk-like rotor (32).

According to this embodiment, the spacing between disk-like rotor (32) and the inner wall of the housing (31) can be 9 (mm), the rotating speed of the disk-like rotor (32) can be 100 (RPM), and the temperature of the heater (33) can be 200° C. In operation, a pellet of low density polyethylene (LDPE) are fed into the inlet (311) and forced to be molten and mixing between disk-like rotor (32) and the inner wall of housing (31), and turned to be a non-Newtonian fluid. Due to the rod climbing effect in the non-Newtonian fluid, the molten and well mixing fluid is extruded axially from the outlet (312) by the extrusion pressure, and then introduced into the front of an injection plunger. The result has shown the embodiment of plasticizing unit (30) can deliver a molten fluid from outlet (312) continuously at the speed of 20.7 grams per minute. It has shown that the plasticizing unit (30) can be applied in micro injection molding field which does not need high pressure to extrude melt; therefore it is applicable for micro injection molding.

The embodiment of the plasticizing unit (30) according to the present invention continuously extrudes the molten and well mixed plastic from outlet (312) of the housing, and then introduces it into the heating cylinder (23) of the micro injection molding machine (20). The driving unit (21) drives the injection plunger (22) to complete a micro injection molding stroke.

As shown in FIG. 3, another embodiment of plasticizing unit (40) in accordance with the present invention, may comprise a housing (41) and a disk-like rotor (42), wherein the disk-like rotor (42) is continuously running in the housing (41). The housing (41) can heat the plastic or resin pellets within the housing (41) by heaters (43), and has an inlet (411) and an outlet (412). The position of outlet (412) is next to the center of the disk-like rotor (42). In this embodiment, the disk-like rotor (42) and shaft (421) are controlled by a reciprocal driving mechanism; therefore, the disk-like rotor (42) is forced to move along its axis reciprocally in the housing (41), and the mixing and blending of the melt is thus enhanced.

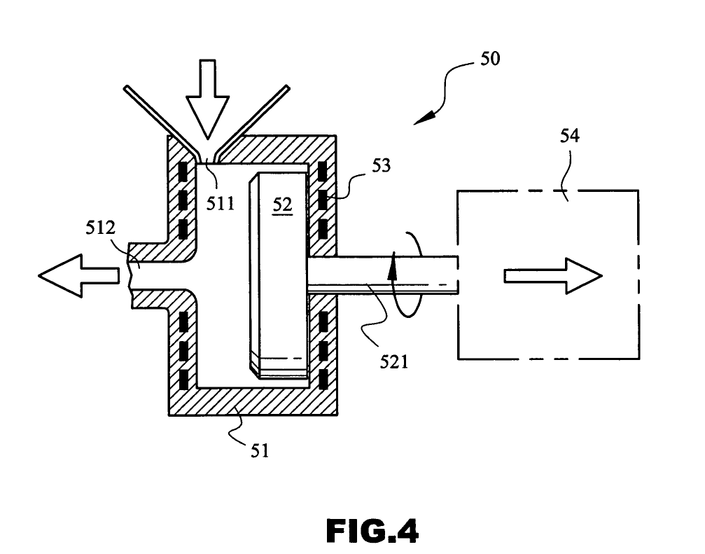

As shown in FIG. 4, a further embodiment of the plasticizing unit (50) in accordance with the present invention, may comprise a housing (51) and a disk-like rotor (52), wherein the disk-like rotor (52) is continuously running in the housing (51). The housing (51) utilizes heater (53) to heat a plastic or resin pellets inside the housing (51), having inlet (511) and outlet (512), wherein the position of outlet (512) is next to the center of the disk-like rotor (52). The shaft (521) of the disk-like rotor (52) is controlled by a back pressure driving mechanism (54), by which can exert a back pressure on the disk-like rotor (52) in order to regulate the pressure change between the disk-like rotor (52) and the housing (51).

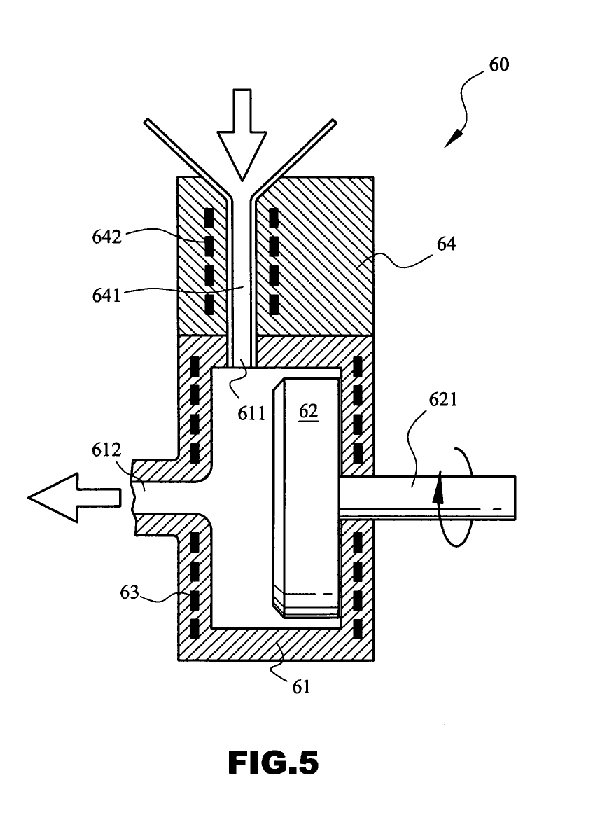

As shown in FIG. 5, is yet another embodiment of plasticizing unit (60) according to the present invention, may comprise a housing (61) and a disk-like rotor (62) wherein the disk-like rotor (62) is running continuously in the housing (61). The housing (61) has an inlet (611) and an outlet (612), and utilizes heater (63) to heat the plastic or resin pellets fed from the inlet (611), wherein the position of outlet (612) is next to the center of the disk-like rotor (62). In this embodiment, a pre-plasticizing unit (64) is connected to the inlet (611). The pre-plasticizing unit (64) having a passage (641) heated with a heater (642), the plastic or resin pellets is heated by the heater (642) when passing through the passage (641), to accelerate the melting and mixing process in the plasticizing unit (60).

The above embodiments are used only to illustrate the present invention, and it is not intended to limit the scope thereof. A person skilled in the art will readily recognize similar variations and alternative embodiments of the present invention, without departing from the spirit of the present invention.

We claim:

1. A plasticizing unit for micro injection molding machine comprising:
a housing, having an inner wall, an inlet and an outlet, wherein said inlet is used to receive a polymeric pellets through the inlet; and
a disk-like rotor, being (rotatably) installed within the housing and kept running continually with a shaft, while the pellets are fed from the inlet, the disk-like rotor may perform a melting and mixing process within the space between the disk-like rotor and the inner wall of the housing; therefore, to transform the polymeric pellets into a molten and well mixed status of non-Newtonian fluid; while the disk-like rotor rotates, a rod climbing effect would occur to generate an extrusion force to make the fluid flow out from the outlet of the housing to the micro injection molding machine for micro injection.

2. The plasticizing unit in accordance with claim 1, wherein the micro injection molding machine comprising an injection plunger and a driving unit, and using the driving unit to push the injection plunger for injecting the fluid to a micro molding cavity.

3. The plasticizing unit in accordance with claim 2, wherein the micro injection molding machine further comprising a heating cylinder to temporarily receive the fluid for a further injection molding cycle.

4. The plasticizing unit in accordance with claim 1, further comprising a heater associated with the housing to heat the pellets within the housing.

5. The plasticizing unit in accordance with claim 1, further comprising a reciprocal driving mechanism, wherein said reciprocal driving mechanism is used to drive the disk-like rotor reciprocally to move along the axis thereof inside the housing.

6. The plasticizing unit in accordance with claim 1, further comprising a back pressure driving mechanism to regulate the pressure between the shaft and the housing.

7. A plasticizing unit for micro injection molding machine comprising:
a housing, having an inner wall, an inlet and an outlet, wherein said inlet is use to receive a polymeric pellets through the inlet;
a pre-plasticizing unit, having a passage for allowing a polymeric pellets to pass through;
a heater, associated with the passage to heat the polymeric pellets; and
a disk-like rotor, being (rotatably) installed within the housing and kept running continually with a shaft, while the pellets are fed from the inlet, the disk-like rotor may perform a melting and mixing process within the space between the disk-like rotor and the inner wall of the housing; therefore, to transform the polymeric pellets into a molten and well mixed status of non-Newtonian fluid; while the disk-like rotor rotates, a rod climbing effect would occur to generate an extrusion force to make the fluid flow out from the outlet of the housing to the micro injection molding machine for micro injection.

8. The plasticizing unit in accordance with claim 7, wherein the micro injection molding machine comprising an injection plunger and a driving unit, and using the driving unit to push the injection plunger for injecting the fluid to a micro molding cavity.

9. The plasticizing unit in accordance with claim 8, wherein the micro injection molding machine further comprising a heating cylinder to temporarily receive the fluid for a further injection molding cycle.

10. The plasticizing unit in accordance with claim 7, further comprising a heater associated with the housing to heat the pellets within the housing.

11. The plasticizing unit in accordance with claim 7, further comprising a reciprocal driving mechanism, wherein said reciprocal driving mechanism is used to drive the disk-like rotor reciprocally to move along the axis thereof inside the housing.

12. The plasticizing unit in accordance with claim 7, further comprising a back pressure driving mechanism to regulate the pressure between the shaft and the housing.
